(19) United States
(12) Patent Application Publication
(10) Pub. No.: US 2017/0068686 A1
(43) Pub. Date: Mar. 9, 2017

(54) ACCESSING A BLOCK BASED VOLUME AS A FILE BASED VOLUME

(71) Applicant: JACOB BROIDO, Tel Aviv (IL)

(72) Inventor: JACOB BROIDO, Tel Aviv (IL)

(21) Appl. No.: 14/846,859

(22) Filed: Sep. 7, 2015

(51) Int. Cl. G06F 17/30; H04L 29/08

(52) U.S. Cl. CPC G06F 17/30203; H04L 67/06; H04L 67/1097; G06F 17/30076

(57) ABSTRACT

A method for accessing a block level volume by a file level client, the method may include receiving, by a network attached storage (NAS) interface of a storage system, a file level command that is associated with a virtual pathname that is indicative that the file level command is aimed to a given block level volume and not to a file of a file system; translating, by the storage system, the file level command to a block level command for accessing the given block level volume; accessing, by the storage system, the given block level volume to provide a block level response; converting, by the storage system, the block level response to a file level response; and sending to the file level client the file level response

### BACKGROUND

Storage systems can be divided to two main types: block level storage and file level storage. A block level storage system handles block level volumes, sometimes called LUNs, which are raw volumes that contain, from the storage system's perspective, a bunch of blocks, where the internal structures and metadata stored therein, are not known to the storage system and not part of its responsibilities.

The block level volumes are exposed to external servers connected to the block level storage system, usually called hosts and may be application servers, SQL servers, virtual machine servers, etc. The content of the block level volumes and their internal structure and format are managed by the hosts that can format the block level volumes as filesystems or databases or any other application level format. Block level storage is usually deployed in SAN (storage area network) environment.

When forwarding requests from the application, running on the host, towards the block level storage system, the host translates the application requests, from the format that is known to the application (e.g., filesystem request or SQL request) into block level commands running on top of block level protocols (also called SAN protocols), for example, SCSI commands over iSCSI or Fibre Channel (FC). A block level command identifies the addressed location in the storage by the volume identifier and a block offset within the volume.

The second type of storage system is a file level storage system that manages file level volumes, which includes filesystems that are handled by the storage system itself, rather than being handled by an external host. The file level storage system formats the volumes as filesystems and manages the structure of the content and the metadata (e.g., inode table, super block, directories, file data blocks) of the filesystem within the volume.

File level storage is deployed in NAS (network attached storage) environments, where filesystem clients, coupled to the file level storage system (that acts as a file server), communicate with the storage system by sending filesystem commands using network file protocols, such as NFS and SMB/CIFS. A filesystem command identifies the addressed location in the storage by the filesystem identifier, filename and pathname (or a handle indicative of these names) and a byte offset within the file.

File level storage and block level storage can be integrated in a single storage system, such as InfiniBox®, that supports file level volumes as well as block level volumes within the same box.

### SUMMARY

According to an embodiment of the invention there may be provided a method for accessing a block level volume by a file level client, the method may include receiving, by a network attached storage (NAS) interface of a storage system, a file level command that is associated with a virtual pathname that is indicative that the file level command is aimed to a given block level volume and not to a file of a file system; translating, by the storage system, the file level command to a block level command for accessing the given block level volume; accessing, by the storage system, the given block level volume to provide a block level response; converting, by the storage system, the block level response to a file level response; and sending to the file level client the file level response.

The at least a portion of the block level volume was written in a response to a reception of a block level write command received via a storage access network (SAN) interface of the storage system.

The method may include receiving via a storage access network (SAN) interface of the storage system a block level command from a block level client for accessing the given block level volume; accessing, by the storage system, the given block level volume to provide a block level response; and sending to the block level client the block level response.

The receiving of the file level command may be followed by forwarding the file level command to a translator of the storage system for translating the file level command to the block level command for accessing the given block level volume.

The receiving of the file level command may be preceded by performing a loopback mount command for mounting the file.

The translating of the file level command to the block level command may include accessing a lookup table for providing, in response to the virtual pathname, a volume identifier of the block level volume.

The translating of the file level command to the block level command may include applying a predefined function for providing, in response to the virtual pathname, a volume identifier of the block level volume.

The method may include receiving by the translator translation information for translating virtual pathnames to block level volumes.

According to an embodiment of the invention there may be provided a non-transitory computer readable medium that may store instructions that once executed by a storage system cause the storage system to receive a file level command that was sent through a network attached storage (NAS) interface of the storage system and is associated with a virtual pathname that is indicative that the file level command is aimed to a given block level volume and not to a file of a file system; translate the file level command to a block level command for accessing the given block level volume; access the given block level volume to provide a block level response; convert the block level response to a file level response; and send to the file level client the file level response.

The at least a portion of the block level volume may be written in a response to a reception of a block level write command received via a storage access network (SAN) interface of the storage system.

The non-transitory computer readable medium may store instructions for receiving via a storage access network (SAN) interface of the storage system a block level command from a block level client for accessing the given block level volume; accessing, by the storage system, the given block level volume to provide a block level response; and sending to the block level client the block level response.

The receiving of the file level command may be followed by forwarding the file level command to a translator of the storage system for translating the file level command to the block level command for accessing the given block level volume.

The receiving of the file level command may be preceded by performing a loopback mount command for mounting the file.

The translating of the file level command to the block level command may include accessing a lookup table for providing, in response to the virtual pathname, a volume identifier of the block level volume.

The translating of the file level command to the block level command may include applying a predefined function for providing, in response to the virtual pathname, a volume identifier of the block level volume.

The non-transitory computer readable medium may store instructions for receiving by the translator translation information for translating virtual pathnames to block level volumes.

According to an embodiment of the invention there may be provided a storage system that may include a network attached storage (NAS) interface, a translator and storage units that store multiple block level volumes; wherein the NAS interface may be configured to receive a file level command that is associated with a virtual pathname that is indicative that the file level command is aimed to a given block level volume and not to a file of a file system; wherein the translator may be configured to translate the file level command to a block level command for accessing the given block level volume, to access the given block level volume, to receive a block level response and to convert the block level response to a file level response; and wherein the NAS interface may be configured to send to the file level client the file level response.

The storage system further may include a storage access network (SAN) interface; wherein at least a portion of the block level volume was written in a response to a reception of a block level write command received via the SAN interface.

The storage system further may include a storage access network (SAN) interface; wherein the SAN interface may be configured to receive a block level command from a block level client for accessing the given block level volume; wherein the controller may be configured to access the given block level volume to provide a block level response; and wherein the SAN interface may be configured to send to the block level client the block level response.

The SAN interface may be configured to forward the file level command to the translator.

The translator may be configured to access a lookup table for providing, in response to the virtual pathname, a volume identifier of the block level volume.

The translator may be configured to translate the file level command to the block level command by applying a predefined function for providing, in response to the virtual pathname, a volume identifier of the block level volume

The translator may be configured to receive translation information for translating virtual pathnames to block level volumes.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a storage system, a management station, a SAN client and a NAS client and their environment according to an embodiment of the invention;

FIG. 2 illustrates a storage system, a management station, a SAN client and a NAS client and their environment according to an embodiment of the invention;

FIG. 3 illustrates a storage system, a management station, a SAN client and a NAS client and their environment according to an embodiment of the invention;

FIG. 4 illustrates a storage system, a management station, a SAN client and a NAS client and their environment according to an embodiment of the invention;

FIG. 5 illustrates a method according to an embodiment of the invention; and

FIG. 6 illustrates a method according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

The following storage system and method enables a NAS client that does not have a SAN interface (i.e., Fibre Channel or iSCSI) to access a volume that was originally created as a block level volume that is enabled for access by SAN clients as a SCSI LUN. In order for enabling access to a NAS client, the following embodiments expose the volume as if it is a file within a filesystem that can be accessed via NAS interface.

The storage system described herein is capable of interfacing with client computers over either NAS or SAN protocols. The storage system includes block level volumes (LUNs) that are accessed by SAN clients via block level (SAN) commands and protocols, such as SCSI over iSCSI or FC. The storage system may also include file level volumes that are accessed via network file protocols, such as NFS or CIFS.

According to embodiments of the invention, a volume that was created as a block level (SAN) volume and written with filesystem content by a SAN client (host), using block level commands (e.g., SCSI) towards the storage system, can be exposed to a NAS client as a file in a filesystem, i.e., allowing filesystem commands towards the block level volume, even though the storage system is not familiar with the filesystem content that was written by the host, nor the format and type of the filesystem stored in the block level volume. It is noted that the NAS client cannot access the block level volume using block level commands/protocol, since the NAS client may not have SAN capabilities. It is assumed that the permissions assigned to the filesystem and the file that represents the volume, are defined as read/write permission or at least read only permission, at least for the discussed NAS client, as done with any file and as known in the art.

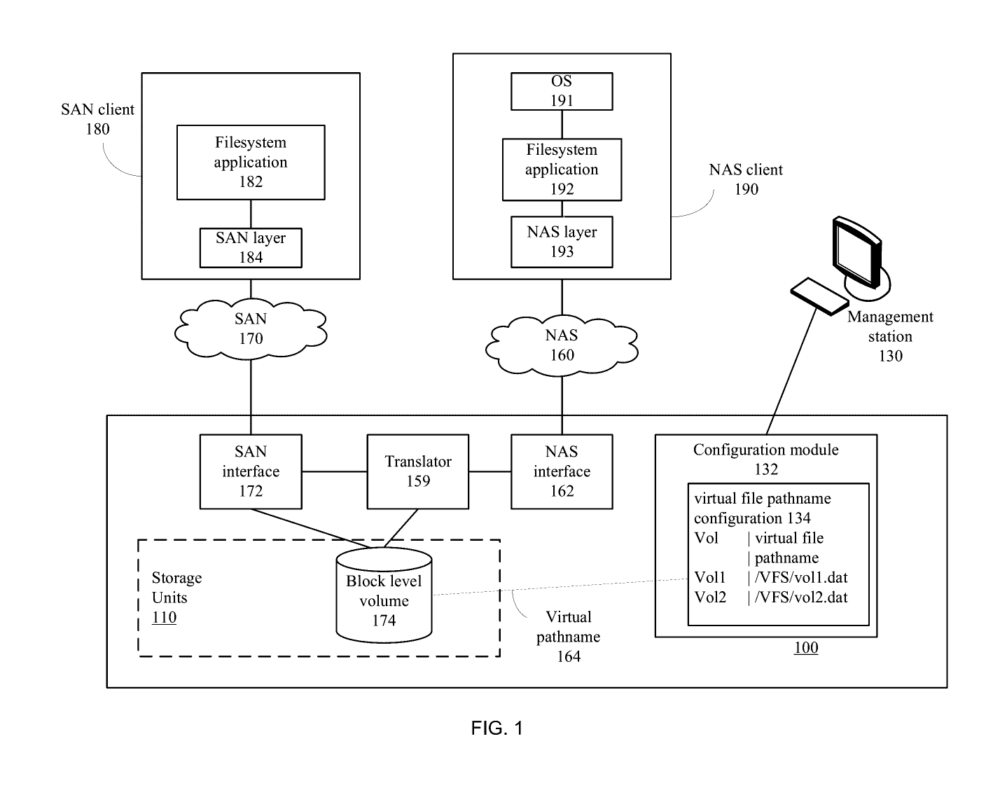

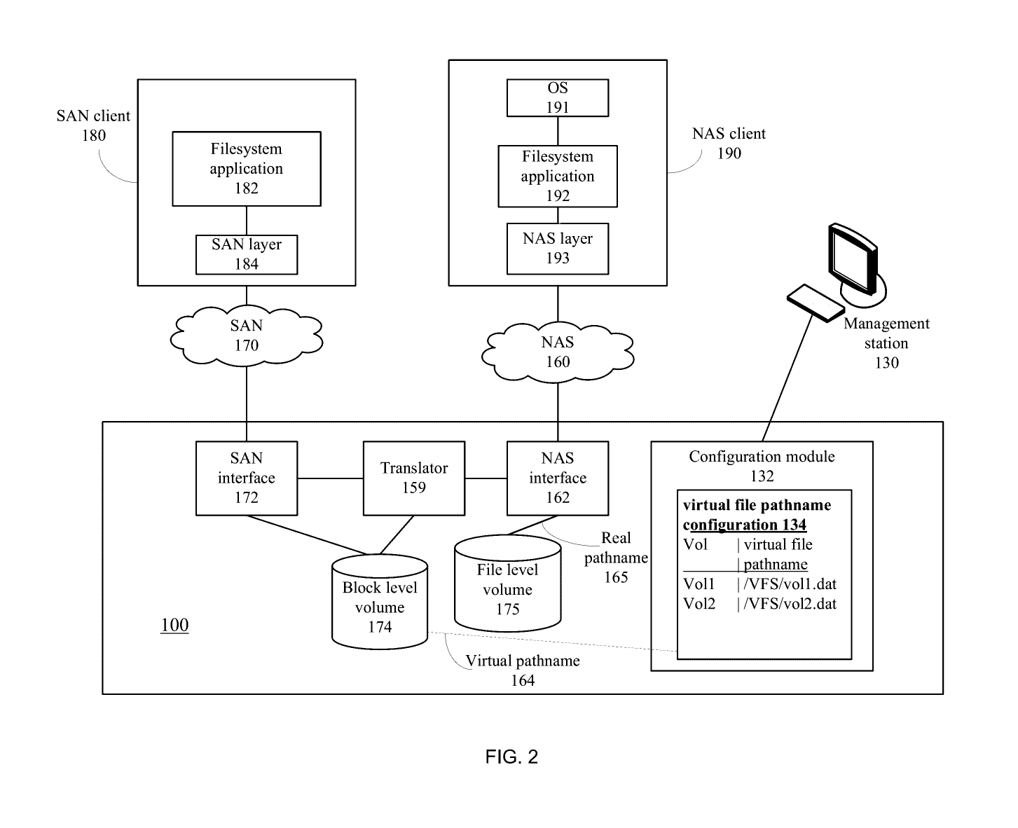

FIGS. 1 and 2 illustrate a storage system 100, management station 130, SAN client computer 180, NAS client computer 190 and their environment according to an embodiment of the invention.

SAN network 170 couples storage system 100 to SAN client computer 180. NAS network 160 couples storage system 100 to NAS client computer 190.

Storage system 100 includes SAN interface 172, NAS interface 162, translator (such as NAS-SAN convertor) 159, configuration module 132 and multiple storage units 110.

The multiple storage units 110 may be configured to store multiple volumes. The storage units 110 may include non-volatile storage units such as solid state memories, disks, and the like. The storage units 110 may include a cache memory, volatile memory and the like.

FIGS. 1 and 2 illustrate a block level volume 174. The block level volume 174 may be initially created to be used by SAN client computer 180. For example—at least a portion of the block level volume was written in a response to a reception of a block level write command received via a storage access network (SAN) interface of the storage system

It is noted that the storage system 100 may store, at least during one or more periods, only block level volumes. This is illustrated in FIG. 1. It is further noted that the storage system 100 may store, at least during one or more other periods, one or more file level volumes as well as one or more block level volumes—as illustrated in FIG. 2. FIG. 2 illustrates a file level volume 175 (accessible by NAS interface 162) and the block level volume 174.

Referring back to FIG. 1—the creation of block level volume 174 by the storage system includes adding a LUN definition in the storage system 100 for block level volume 174. For example—SAN client computer 180 may established the content of volume 174, e.g., formatted the volume in a certain filesystem format and wrote filesystem content to the volume, by sending write block level commands.

SAN client computer 180 includes at least the following modules: (i) a filesystem application 182 that produces client filesystem access commands; and (ii) a SAN layer 184 that translates the client filesystem access commands into block level commands transmitted via SAN 170 and SAN interface 172 towards block level volume 174 of storage system 100.

The block level commands comply with a block level protocol, such as but not limited to SCSI.

SAN layer 184 facilitates coupling SAN client computer 180 to storage system 100 via SAN network 170.

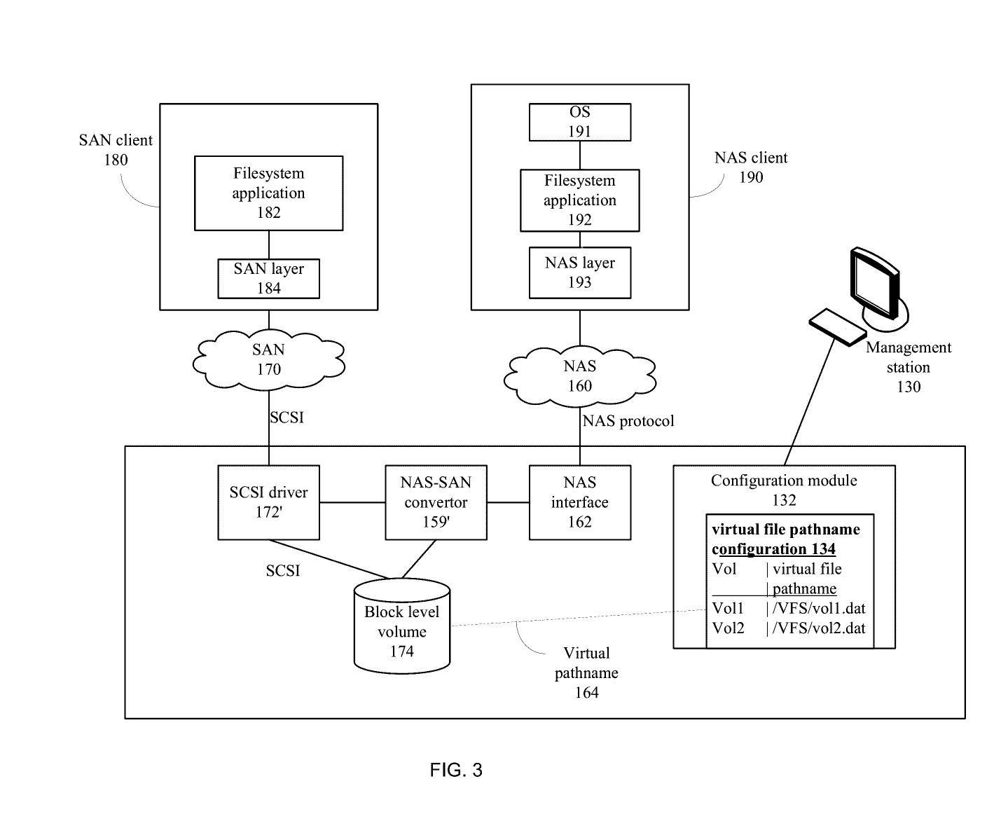

SAN interface 172 of storage system 100 may be configured to receive the block level commands and may access block level volume 174. One of the communication protocols that can be used by the SAN client computer is SCSI and FIG. 3 illustrates the SAN interface as being a SCSI driver 172′.

A block level access command includes at least an identification of the volume (e.g., SCSI LUN), an offset within the volume and the size to be read/write. The offset and the size maybe measured in block units (e.g., 512 bytes).

At any point in time after block level volume 174 has been created and written with content by the SAN client computer 180, a NAS client computer 190 may wish to read files stored in block level volume 174.

NAS client computer 190 includes at least the following modules: (i) an Operating System (OS) 191, such as Linux, that is capable of: supporting a loopback mount′ command for mounting a file that includes a filesystem; parsing of a filesystem so as to detect the type and format of the filesystem; (ii) filesystem application 192 for generating filesystem commands, and (iii) NAS layer 193 that transmits and receives the file system commands as NAS protocol messages, such as NFS or CIFS messages.

NAS layer 193 facilitates coupling the NAS client computer 190 to storage system 100 via a NAS network 160.

The NAS protocol messages are received by NAS interface 162 of storage system 100.

According to embodiments of the present invention, the block level volume 174 is associated with a virtual file pathname 164, e.g., /VFS/vol1.dat or/VFS/LoopBackMount/vol1.dat, where/VFS, /VFS/LoopBackMount are examples of virtual pathnames that includes one or more virtual directories rather than real directories.

The specific name (e.g., the term ‘VFS’) of the virtual path indicates that a client wishes to access a block level volume via a NAS protocol. The virtual path (e.g., /VFS) may be common to all virtual file pathnames associated with block level volumes that need to be exported as filesystems. For example, the path /VFS/vol1.dat is associated with block level volume 174, the path/VFS/vol2.dat is associated with another block level volume (not shown), etc.

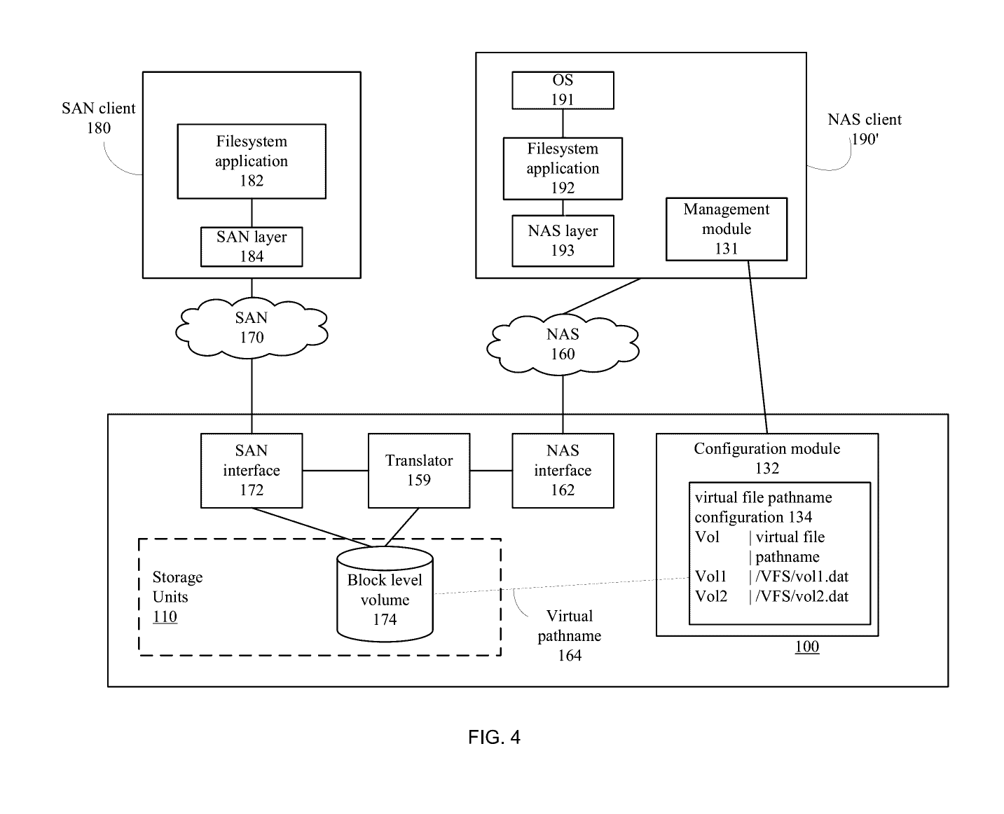

The association of the virtual file pathnames to block level volumes may be defined by an administrator using a management station 130 that includes a user interface for defining the virtual file pathnames and their association to block level volumes. In FIG. 4 the management station 130 is replaced by a management module 131 within NAS client 190′.

Management station 130 is coupled to storage system 100, e.g., to a configuration module 132, using a management protocol, such as HTTP.

Management station 130 sends virtual file pathname configuration to configuration module 132.

Configuration module 132 of storage system 100 stores translation information such as virtual file pathname configuration 134, which includes one or more pairs of block level volume and virtual file pathname.

Alternatively, the storage system 100 can automatically assign virtual file pathnames to all or part of the block level volumes stored in storage system 100. For example, the file name may be the name of the volume, the file extension may be a predefined extension name, e.g., “.dat” and the directory path may be a predefined virtual directory name, e.g., “/VFS”/.

In either embodiment, the virtual file pathname associated with a specific volume, should be known to both the storage system 100 and the NAS client computer 190.

When NAS client computer 190 wishes to access objects (files, directories) stored in block level volume 174, it performs a loopback mount command provided by OS 191 to mount the virtual file represented by virtual file pathname 164. After the loopback mount, NAS client computer 190 can send file system commands (access requests) directed to the virtual file pathname 164 and encapsulated by the NAS protocol.

Referring to FIG. 3—when NAS module 162 receives from NAS client computer 190 a NAS protocol message that includes a file system command for accessing a file having a virtual file pathname, the following sequence is performed:
a. NAS module 162 determines that the virtual file pathname is indicative of a block level volume and forwards the file system command to NAS-SAN converter 159′. NAS module 162 recognizes the predetermined term, e.g., VFS, included in the virtual file pathname, when determining that the request is directed to a block level volume, rather than to a real file.
b. NAS-SAN converter 159′ identifies a block level volume associated with the virtual file pathname. The virtual file pathname configuration 134 may be used for identifying the block level volume. Alternatively, NAS-SAN converter 159′ can use a predetermined formula for file-to-volume name transformation.
c. NAS-SAN converter 159′ translates the file system command into a block based command (e.g., SCSI command or a proprietary internal block command). The translation may include translating the offset requested within the file into a block offset within the block based volume. For example, the NAS command may be NFS-READ and the translated block based command maybe SCSI-READ.
d. The block based command is used for accessing the block based volume rather than accessing the file.
e. NAS-SAN converter 159′ may forward a SCSI access-command to SCSI driver 172, which in turn access the block based volume for reading or writing. Alternatively, the block based command may have another format rather than SCSI, e.g., a proprietary format, and the NAS-SAN converter 159′ may access the block based volume directly. Accessing the volume may include accessing a cache memory that caches content of the volume and/or accessing one or more disk drives that stores content of the volume.
f. NAS-SAN converter 159′ receives a response from the block based volume (e.g., data that was read or status of write) and sends a corresponding NAS response message to the NAS client computer 190.

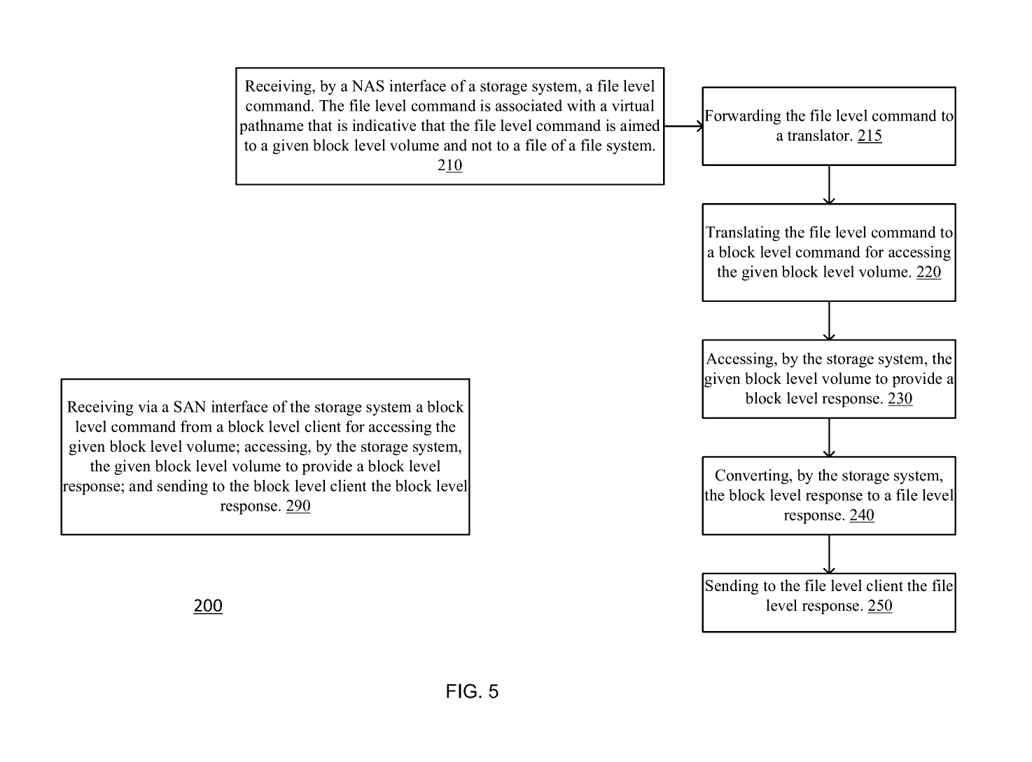

FIG. 5 illustrates method 200 according to an embodiment of the invention.

Method 200 may start by step 210 of receiving, by a NAS interface of a storage system, a file level command. The file level command is associated with a virtual pathname that is indicative that the file level command is aimed to a given block level volume and not to a file of a file system. The file level command may be a NAS protocol command, e.g., NFS-READ or NFS-WRITE or similar CIFS/SMB commands.

Step 210 may be preceded by performing, by the NAS client, a loopback mount command for mounting the file.

Step 210 may be followed by step 215 of forwarding the file level command to a translator. If the virtual pathname is not explicitly included in the file level command (e.g., the virtual pathname may be indicated by a file handle within an NFS command), then the virtual pathname is also sent to the translator.

Step 215 may be followed by step 220 of translating the file level command to a block level command for accessing the given block level volume. The translating may include accessing a lookup table (such as virtual file pathname configuration file) for translating the virtual pathname into a volume identifier of the given block level volume, applying a function on the virtual pathname for obtaining the volume identifier of the given block level volume, and the like. The translating may include calculating the block address (e.g., LBA) to be accessed, according to a file offset included in the file level command, taking into account the block size used by the given block level volume and any reserved areas at the start addresses of the volume that may be reserved for internal use.

Step 220 may be followed by step 230 of accessing, by the storage system, the given block level volume to provide a block level response. The block level response may include the data that was requested to be read or a notification that data was safely written to the given block level volume.

Step 230 may be followed by step 240 of converting, by the storage system, the block level response to a file level response. The file level response may be a NAS protocol response, e.g., NFS-READ response.

Step 240 may be followed by step 250 of sending to the file level client the file level response.

Method 200 may also include step 290 of receiving via a SAN interface of the storage system a block level command from a block level client for accessing the given block level volume; accessing, by the storage system, the given block level volume to provide a block level response; and sending to the block level client the block level response.

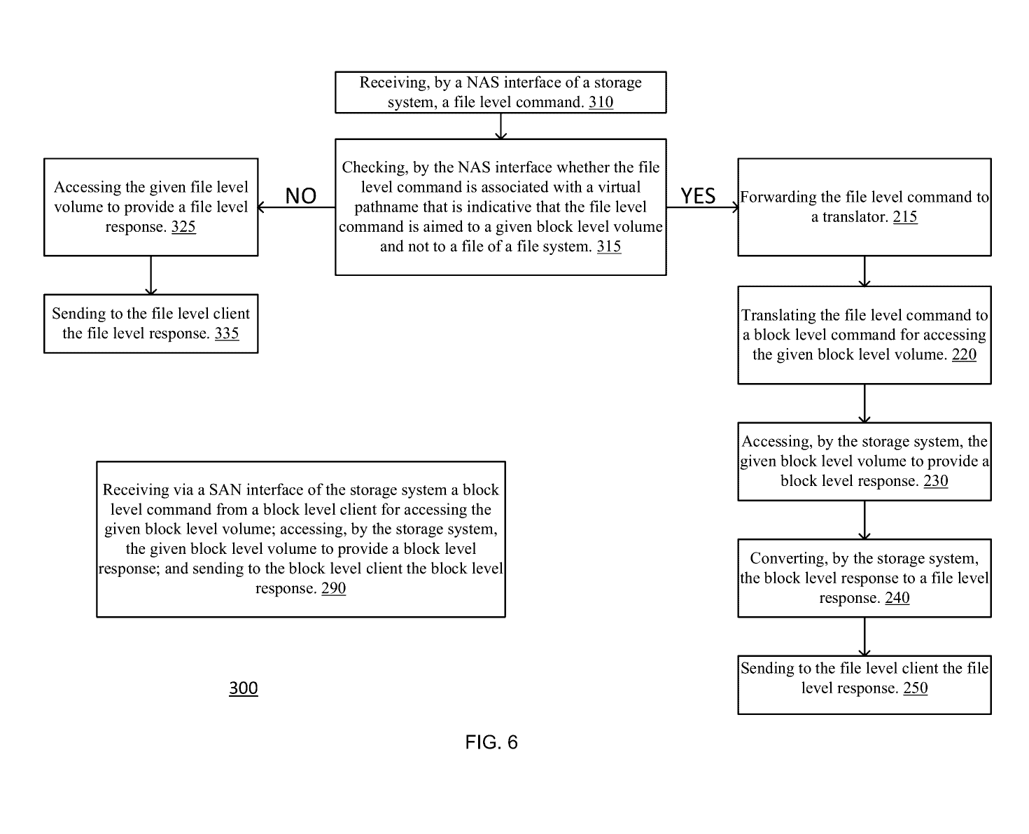

FIG. 6 illustrates method 300 according to an embodiment of the invention. It is assumed that method 300 allows both file level accesses and block level accesses.

Method 300 may start by step 310 of receiving, by a NAS interface of a storage system, a file level command.

Step 310 may be followed by step 315 of checking, by the NAS interface whether the file level command is associated with a virtual pathname that is indicative that the file level command is aimed to a given block level volume and not to a file of a file system.

If the answer is positive then step 315 is followed by step 215 of forwarding the file level command to a translator. If the virtual pathname is not included in the file level command then the virtual pathname is also sent to the translator.

Step 215 may be followed by step 220 of translating the file level command to a block level command for accessing the given block level volume.

Step 220 may be followed by step 230 of accessing, by the storage system, the given block level volume to provide a block level response.

Step 230 may be followed by step 240 of converting, by the storage system, the block level response to a file level response.

Step 240 may be followed by step 250 of sending to the file level client the file level response.

When step 315 determines that the file level command is associated with a real pathname related to a given file level volume then step 315 is followed by step 325 of accessing the given file level volume to provide a file level response.

Step 325 may be followed by step 335 of sending to the file level client the file level response.

Method 300 may also include step 290 of receiving via a SAN interface of the storage system a block level command from a block level client for accessing the given block level volume; accessing, by the storage system, the given block level volume to provide a block level response; and sending to the block level client the block level response.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for accessing a block level volume by a file level client, the method comprises:
receiving, by a network attached storage (NAS) interface of a storage system, a file level command that is associated with a virtual pathname that is indicative that the file level command is aimed to a given block level volume and not to a file of a file system;
translating, by the storage system, the file level command to a block level command for accessing the given block level volume;
accessing, by the storage system, the given block level volume to provide a block level response;
converting, by the storage system, the block level response to a file level response; and
sending to the file level client the file level response.

2. The method according to claim 1 wherein at least a portion of the block level volume was written in a response to a reception of a block level write command received via a storage access network (SAN) interface of the storage system.

3. The method according to claim 1 comprising receiving via a storage access network (SAN) interface of the storage system a block level command from a block level client for accessing the given block level volume; accessing, by the storage system, the given block level volume to provide a block level response; and sending to the block level client the block level response.

4. The method according to claim 1 wherein the receiving of the file level command is followed by forwarding the file level command to a translator of the storage system for translating the file level command to the block level command for accessing the given block level volume.

5. The method according to claim 1 wherein the receiving of the file level command is preceded by performing a loopback mount command for mounting the file.

6. The method according to claim 1 wherein the translating of the file level command to the block level command comprises accessing a lookup table for providing, in response to the virtual pathname, a volume identifier of the block level volume.

7. The method according to claim 1 wherein the translating of the file level command to the block level command comprises applying a predefined function for providing, in response to the virtual pathname, a volume identifier of the block level volume.

8. The method according to claim 1 comprising receiving, by the translator, translation information for translating virtual pathnames to block level volumes.

9. A non-transitory computer readable medium that stores instructions that once executed by a storage system cause the storage system to:
receive a file level command that was sent through a network attached storage (NAS) interface of the storage system and is associated with a virtual pathname that is indicative that the file level command is aimed to a given block level volume and not to a file of a file system;
translate the file level command to a block level command for accessing the given block level volume;
access the given block level volume to provide a block level response;
convert the block level response to a file level response; and
send to the file level client the file level response.

10. The non-transitory computer readable medium according to claim 9 wherein at least a portion of the block level volume was written in a response to a reception of a block level write command received via a storage access network (SAN) interface of the storage system.

11. The non-transitory computer readable medium according to claim 9 that stores instructions for:
receiving via a storage access network (SAN) interface of the storage system a block level command from a block level client for accessing the given block level volume;
accessing, by the storage system, the given block level volume to provide a block level response; and
sending to the block level client the block level response.

12. The non-transitory computer readable medium according to claim 9 wherein the receiving of the file level command is followed by forwarding the file level command to a translator of the storage system for translating the file level command to the block level command for accessing the given block level volume.

13. The non-transitory computer readable medium according to claim 9 wherein the receiving of the file level command is preceded by performing a loopback mount command for mounting the file.

14. The non-transitory computer readable medium according to claim 9 wherein the translating of the file level command to the block level command comprises accessing a lookup table for providing, in response to the virtual pathname, a volume identifier of the block level volume.

15. The non-transitory computer readable medium according to claim 9 wherein the translating of the file level command to the block level command comprises applying a predefined function for providing, in response to the virtual pathname, a volume identifier of the block level volume.

16. The non-transitory computer readable medium according to claim 9 that stores instructions for receiving by the translator translation information for translating virtual pathnames to block level volumes.

17. A storage system that comprises a network attached storage (NAS) interface, a translator and storage units that store multiple block level volumes;
wherein the NAS interface is configured to receive a file level command that is associated with a virtual pathname that is indicative that the file level command is aimed to a given block level volume and not to a file of a file system;
wherein the translator is configured to translate the file level command to a block level command for accessing the given block level volume, to access the given block level volume, to receive a block level response and to convert the block level response to a file level response; and
wherein the NAS interface is configured to send to the file level client the file level response.

18. The storage system according to claim 17 further comprising a storage access network (SAN) interface; wherein at least a portion of the block level volume was written in a response to a reception of a block level write command received via the SAN interface.

19. The storage system according to claim 17 further comprising a storage access network (SAN) interface; wherein the SAN interface is configured to receive a block level command from a block level client for accessing the given block level volume; wherein the controller is configured to access the given block level volume to provide a block level response; and wherein the SAN interface is configured to send to the block level client the block level response.

20. The storage system according to claim 17 wherein the SAN interface is configured to forward the file level command to the translator.

21. The storage system according to claim 17 wherein the translator is configured to access a lookup table for providing, in response to the virtual pathname, a volume identifier of the block level volume.

22. The storage system according to claim 17 wherein the translator is configured to translate the file level command to the block level command by applying a predefined function for providing, in response to the virtual pathname, a volume identifier of the block level volume.

23. The storage system according to claim 17 wherein the translator is configured to receive translation information for translating virtual pathnames to block level volumes.
